(19) United States
(12) Patent Application Publication
(10) Pub. No.: US 2026/0300818 A1
(43) Pub. Date: Oct. 1, 2026

(54) MACHINE LEARNING MODEL INFERENCE SIMULATION

(71) Applicant: eBay Inc., San Jose, CA (US)

(72) Inventors: Bing Wang, Shanghai (CN); Junhao Gao, Shanghai (CN); Chunlin Bao, Shanghai (CN); Guansheng Zhu, Shanghai (CN); Yao Wei, Shanghai (CN); Weiming Liang, Shanghai (CN); Cheng Lan, Shanghai (CN); Shu Fan, Shanghai (CN); Yinan Shan, Shanghai (CN); Yang Zhao, Shanghai (CN); Xin LI, Shanghai (CN); Qiang Wang, PuDong (CN); Ai Gong, Shanghai (CN)

(21) Appl. No.: 19/096,290

(22) Filed: Mar. 31, 2025

(51) Int. Cl. G06N 20/00; G06N 5/04

(52) U.S. Cl. CPC G06N 20/00; G06N 5/04

(57) ABSTRACT

Example embodiments are directed to a system that facilitates machine learning model inference simulation. A model inference simulation request is received. A model specification is identified based on the model inference simulation request. A job workflow is generated based on the model specification and the model inference simulation request. A model inference simulation result is generated using a machine learning model associated with the model specification. The model inference simulation result is then caused to be displayed on a user interface.

### TECHNICAL FIELD

The present disclosure generally relates to data processing using machine learning technologies. More particularly, various embodiments described herein provide for systems, methods, techniques, instruction sequences, and devices that facilitate machine learning model inference simulation for runtime consistency and performance optimization across distributed computing environments.

### BACKGROUND

The lifecycle of a machine learning model can encompass several stages, including feature engineering, model training, deployment, integration, validation, and serving. Each stage is essential to ensure models perform reliably and effectively within production environments. In particular, the deployment and integration of machine learning models into production environments present significant challenges. For example, ensuring runtime consistency across different environments, such as offline training, simulation, and online serving, is a considerable challenge. Consistency is important for accurate performance evaluation and rapid iteration of model training. Additionally, the efficiency of model simulations directly impacts the efficiency of performance evaluation and model updates.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example environment that includes a data management system, according to various examples of the present disclosure.

FIG. 2 is a block diagram illustrating an example data management system that facilitates machine learning model inference simulation for runtime consistency and performance optimization across distributed computing environments, according to various examples of the present disclosure.

FIG. 3 is a flowchart illustrating an example method for facilitating machine learning model inference simulation for runtime consistency and performance optimization across distributed computing environments, according to various examples of the present disclosure.

FIG. 4 is a flowchart illustrating an example method for facilitating machine learning model inference simulation for runtime consistency and performance optimization across distributed computing environments, according to various examples of the present disclosure.

FIG. 5 is a block diagram illustrating an example data flow that facilitates machine learning model inference simulation for runtime consistency and performance optimization across distributed computing environments, according to various examples of the present disclosure.

FIG. 6 is a block diagram illustrating an example data flow that facilitates machine learning model inference simulation for runtime consistency and performance optimization across distributed computing environments, according to various examples of the present disclosure.

FIG. 7 is a block diagram illustrating an example model specification that facilitates machine learning model inference simulation for runtime consistency and performance optimization across distributed computing environments, according to various examples of the present disclosure.

FIG. 8 is a block diagram illustrating a representative software architecture, which may be used in conjunction with various hardware architectures herein described, according to various examples of the present disclosure.

FIG. 9 is a block diagram illustrating components of a machine able to read instructions from a machine storage medium and perform any one or more of the methodologies discussed herein according to various examples of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details. Furthermore, well-known features may be omitted or simplified in order not to obscure the described embodiments.

Various examples include systems, methods, and non-transitory computer-readable media that facilitate machine learning model inference simulation for runtime consistency and performance optimization across distributed computing environments, according to various examples of the present disclosure. Various examples involve a robust solution for model inference simulation, addressing the need for offline accessibility of model inference results consistent with the online production environment. Model inference simulation is designed to replicate outputs of online model inference to evaluate a model's offline training results before integrating the model into existing workflows in the production environment. Model inference simulation can help speed up models' performance evaluation and subsequent model updates. Specifically, upon receiving a model inference simulation request, a data management system identifies a model specification, which includes various information about the model, such as preprocessing code, preprocessing configurations, model files, and runtime metadata. Model specifications are represented by JSON objects. This way, operations discussed in the invention are no longer limited to any type of platform or programming language. A job workflow is then generated and triggered upon retrieving the model specification from the model specification database. Jobs in the workflow are then executed by a distributed computing platform for model inference simulation, including feature processing, model inference, and model output processing. The system supports various model types, including open-source distributed gradient-boosting machine learning frameworks, deep neural networks, and customized machine learning models that support specified data formats.

Overall, various embodiments provide a comprehensive solution for model inference simulation, addressing key challenges in the field of machine learning model deployment and integration. By ensuring runtime consistency, enhancing efficiency through distributed computing, supporting various model types, and enabling rapid model iteration, the technology significantly accelerates the process of AI productionization in the e-commerce domain.

In various embodiments, a data management system receives a model inference simulation request. In particular, the data management system receives model inference simulation requests through multiple access points, including model insight user interfaces, model insight libraries (e.g., Python library), and Application Programming Interfaces (APIs).

In various embodiments, in response to receiving a model inference simulation request, the data management system identifies a model specification based on the request. A model specification can be in JSON format, including metadata associated with the model, such as model object metadata defining model characteristics, feature metadata specifying data transformations, runtime metadata indicating environment requirements, processing codes and configurations, and model file references. Model specifications can be retrieved from a dedicated model specification data store.

Using model specifications in JSON format provides several technical advantages. First of all, this approach provides standardized representation and validation by allowing a consistent portrayal of model characteristics, preprocessing configurations, and runtime requirements. This helps facilitate automated validation of model specifications and parameters. Secondly, this approach supports comprehensive metadata management by capturing complete model metadata, including basic model object details, feature transformation rules, runtime environment parameters, processing codes and configurations, and model file references. Thirdly, this approach allows runtime consistency by maintaining consistent execution across training, simulation, and production environments. Using model specifications in JSON format also helps preserve predetermined versions of required libraries and allows containerized runtime environments with version-controlled specifications. Further, this approach provides version control and traceability by supporting immutable model artifacts in the model management system. It maintains version control for processing codes and configurations, allows tracking of runtime environment specifications, facilitates standardized interfaces for system integration, and allows automated job workflow management. Last but not least, this approach promotes efficient processing by allowing automated parsing and validation of model specifications. It also facilitates rapid initialization of simulation sessions and allows automated configuration of runtime environments.

In various embodiments, the data management system generates a job workflow based on the model specification and the model inference simulation request. A job workflow includes a plurality of jobs, including, without limitation, workflow template selection, workflow initialization, feature processing, model inferencing, and model output processing.

In various embodiments, the data management system uses a machine learning model associated with the model specification to generate a model inference simulation result. The generation of the model inference simulation result includes executing a plurality of jobs based on the job workflow described herein. Specifically, the data management system generates model inference simulation results through a multi-stage execution process. The system initiates model simulation sessions based on model specifications and files to execute a sequence of jobs. The first stage is feature preprocessing, where the data management system processes input data according to specification rules, handles missing value treatments, applies feature transformations, and validates feature consistency. Next, the model inference stage executes the inference using containerized environments, processing data through selected platforms. In the final stage, result postprocessing merges results from parallel jobs, stores the final output in parquet file format, creates table representations (e.g., Hive), and validates output consistency. In particular, the system can store simulation results as both parquet files and Hive tables, where the Hive table provides a quarriable database-like structure for accessing and analyzing the simulation output data.

To maintain runtime consistency, the data management system uses predetermined versions of required libraries, version-controlled model specifications, and containerized execution environments. The execution process supports multiple model frameworks, including models in text format, models in JSON format, deep neural networks in ONNX format, and customized models in PKL format. Under this approach, performance optimization can be achieved through batch processing capabilities, parallel execution across distributed platforms, resource allocation optimization, and real-time performance monitoring. The execution results maintain a desirable compatibility rate between simulation and production environments, allowing for rapid model validation and deployment.

In various embodiments, the data management system causes display of the model inference simulation result on a user interface. Specifically, the model inference simulation results are displayed through multiple user interface options. For example, the model insight user interface can be used as a dedicated interface that provides functionalities for model, version, and feature management,

In various embodiments, the model specification can include preprocessing code, a plurality of preprocessing configurations, a plurality of model files, and runtime metadata. The runtime metadata indicates a runtime environment in which the machine learning model operates. Specifically, the preprocessing code can correspond to feature processing functions and transformations. The processing configurations can control how the preprocessing steps are executed. The model files can be version-controlled and immutable after upload. The immutability ensures consistency and traceability of deployed models. The runtime metadata can include predetermined versions of libraries associated with the models and can also include configuration parameters, such as GPU/CPU allocation, memory requirements, container image specifications, package specifications, and resource configurations.

In various embodiments, the machine learning model associated with the model specification can include one of a distributed gradient-boosting machine learning framework, a deep neural network, or a customized machine learning model that supports specified data formats.

In various embodiments, the plurality of jobs in the job workflow can be arranged in a logical sequence. The plurality of jobs can include a workflow template selection job, a workflow initialization job, a feature processing job, a model inferencing job, and a model output processing job.

In various embodiments, the data management system generates a model specification that includes software code in a programming language (e.g., C++. Python). The code outlines the model's logic, functions, and overall structure, allowing every aspect of the model's behavior to be clearly defined. The data management system converts the model specification into a plurality of JSON objects. These JSON objects serve to structure the model's data in a standardized, lightweight, and easily readable format, allowing for efficient data exchange and processing. Each JSON object can represent a part of the model specification, such as configuration parameters, function definitions, and metadata associated with the model components. The data management system then stores the converted model specification in a database. This storage process allows the model to be securely saved and easily accessible for future reference or updates. This storage process also facilitates version control and integration with other systems that rely on structured data for further processing and deployment.

In various embodiments, the data management system tunes (or trains) the machine learning model based on the model inference simulation result. In particular, the data management system can implement an iterative optimization cycle where model inference simulation results are used to validate and tune (or train) the model before business adoption. If validation fails, the cycle returns to model tuning (or training). If validation passes, the model can proceed to business adoption. The simulation results can help identify potential issues before production deployment, improving the technology or technology field by allowing the model parameters to be refined and tuned to facilitate optimal performance.

In various embodiments, model inference simulation requests can be received via a user interface, a software library, or an API call.

In various embodiments, machine learning models described herein can operate on a distributed computing platform that includes one or more of a distributed computing framework, a software library, and a distributed file system.

In various embodiments, the model specification configured for a machine learning model for model inference simulation can be used for online or offline training (or tuning) of the machine learning model.

Reference will now be made in detail to embodiments of the present disclosure, examples of which are illustrated in the appended drawings. The present disclosure may, however, be embodied in many different forms and should not be construed as being limited to the embodiments set forth herein.

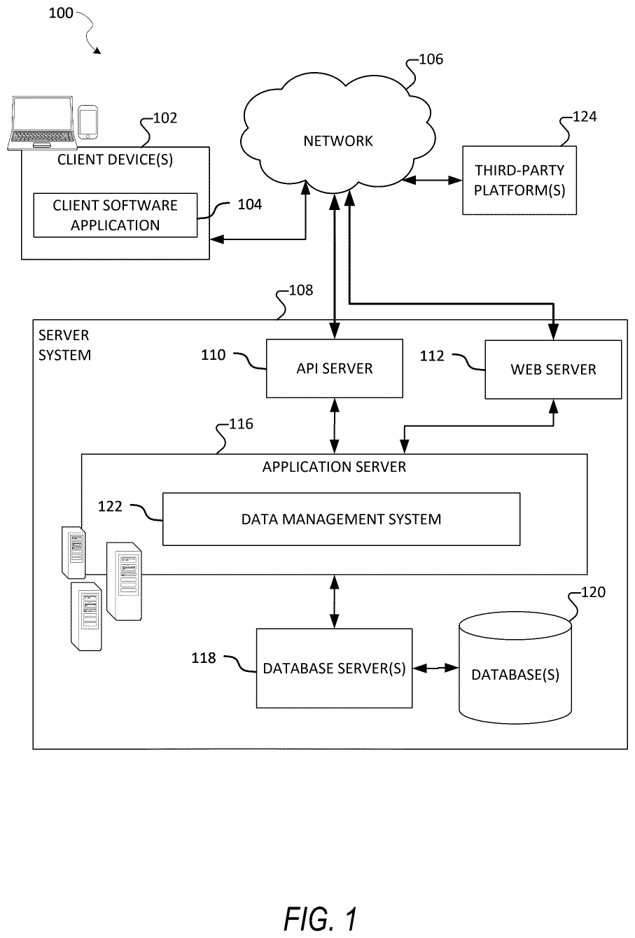

FIG. 1 is a block diagram showing an example environment 100 that includes a data management system 122 (also referred to as system 122), according to various examples of the present disclosure. By including the data management system 122, environment 100 can facilitate machine learning model inference simulation for runtime consistency and performance optimization across distributed computing environments. As shown, environment 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the environment 100 are described herein as being performed by the data management system 122 on the server system 108, it will be appreciated that the location of certain functionality within the server system 108 is a design choice. For example, it may be technically preferable to initially deploy certain technology and functionality within the server system 108, but later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 at the data management system 122, and processing data generated by the client software application 104. Data exchanges within the environment 100 may be invoked and controlled through operations of software component environments available via one or more endpoints or functions available via one or more user interfaces of the client software application 104, which may include web-based user interfaces provided by the server system 108 for presentation at the client device 102.

With respect to the server system 108, an Application Program Interface (API) server 110 and a web server 112 are coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

Through one or more web-based interfaces (e.g., web-based user interfaces), the web server 112 can support various functionality of the data management system 122 of the application server 116.

The environment 100 can also comprise one or more third-party platforms 124. The third-party platform(s) 124 can be a third-party system that performs data operations or processing for the network system 108.

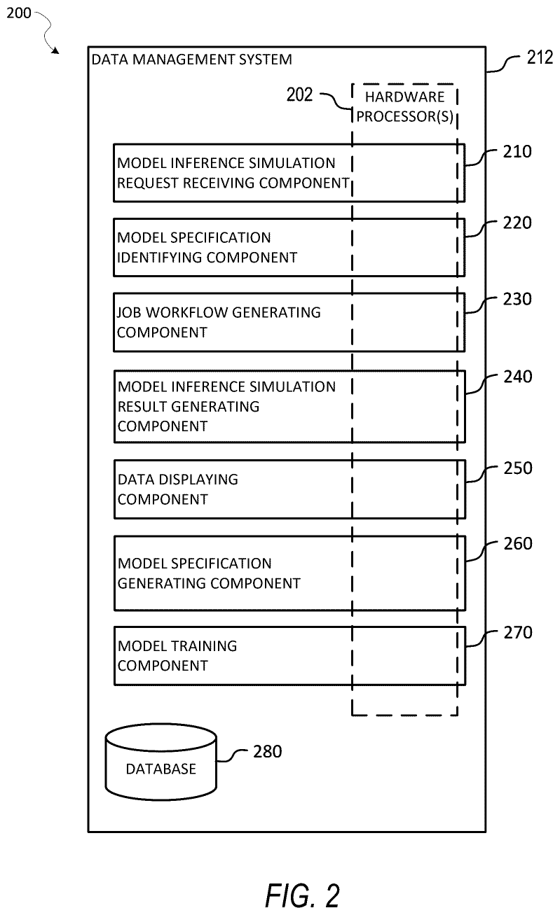

FIG. 2 is a block diagram illustrating an example data management system 212 that facilitates machine learning model inference simulation for runtime consistency and performance optimization across distributed computing environments, according to various examples of the present disclosure. For some examples, the data management system 212 represents an example of the data management system 122 described with respect to FIG. 1. As shown, the data management system 212 comprises a model inference simulation request receiving component 210, a model specification identifying component 220, a job workflow generating component 230, a model inference simulation result generating component 240, a data displaying component 250, a model specification generating component 260, and a model training component 270. According to various examples, one or more of the model inference simulation request receiving component 210, the model specification identifying component 220, the job workflow generating component 230, the model inference simulation result generating component 240, the data displaying component 250, the model specification generating component 260, and the model training component 270 are implemented by one or more hardware processors 202. Data generated by one or more of the model inference simulation request receiving component 210, the model specification identifying component 220, the job workflow generating component 230, the model inference simulation result generating component 240, the data displaying component 250, the model specification generating component 260, and the model training component 270 may be stored in a database (or datastore) 280 of the data management system 212.

The model inference simulation request receiving component 210 is configured to receive model inference simulation requests through multiple access points, including model insight user interfaces, model insight libraries (e.g., Python library), and APIs.

The model specification identifying component 220 is configured to identify model specifications based on the received model inference simulation requests. A model specification can be determined based on a model identifier included in a model inference simulation request. A model specification can be in JSON format, including metadata associated with the model, such as model object metadata defining model characteristics, feature metadata specifying data transformations, runtime metadata indicating environment requirements, processing codes and configurations, and model file references.

The job workflow generating component 230 is configured to generate job workflows based on the model specifications and/or the model inference simulation requests. A job workflow includes a plurality of jobs, including, without limitation, workflow template selection, workflow initialization, feature processing, model inferencing, and model output processing.

The model inference simulation result generating component 240 is configured to use machine learning models to generate model inference simulation results based on the corresponding model specifications. The generation of the model inference simulation result can be a multi-step process that includes executing a plurality of jobs based on the job workflow described herein.

The data displaying component 250 is configured to display data (e.g., model inference simulation results) on devices.

The model specification generating component 260 is configured to generate model specifications based on the types and versions of machine learning models. A model specification includes software code converted into JSON objects for storage. The original software code can be any programming language, such as C++ and Python. Keeping model specifications as JSON objects serves to structure the model's data in a standardized, lightweight, and easily readable format, allowing for efficient data exchange and processing. Each JSON object can represent a part of the model specification, such as configuration parameters, function definitions, and metadata associated with the model components. Once converted, the model specifications are stored in a designated database that allows the models to be securely saved and easily accessible for future reference or updates. This approach can also facilitate version control and integration with other systems that rely on structured data for further processing and model deployment.

The model training component 270 is configured to train (or tune) the machine learning model based on the model inference simulation result. In particular, the data management system can implement an iterative optimization cycle where model inference simulation results are used to validate and tune (or train) the model before business adoption. If validation fails, the cycle returns to model tuning (or training). If validation passes, the model can proceed to business adoption. The simulation results can help identify potential issues before production deployment, improving the technology or technology field by allowing the model parameters to be refined and tuned to facilitate optimal performance.

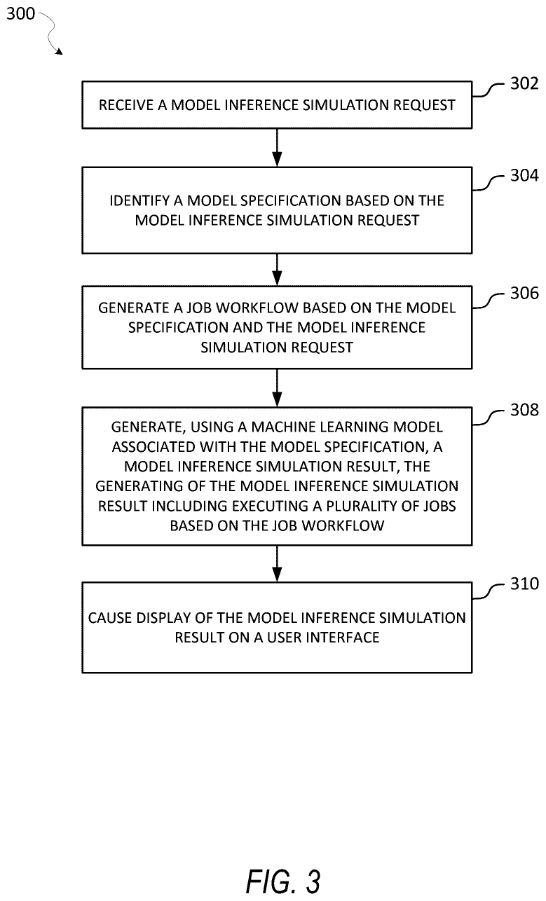

FIG. 3 is a flowchart illustrating an example method 300 for facilitating machine learning model inference simulation for runtime consistency and performance optimization across distributed computing environments, according to various examples of the present disclosure. It will be understood that example methods described herein may be performed by a machine in accordance with some examples. For example, method 300 can be performed by the data management system 122 described with respect to FIG. 1, the data management system 212 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among examples, including performing certain operations in parallel.

At operation 302, a processor receives model inference simulation requests through multiple access points, such as model insight user interfaces, model insight libraries (e.g., Python library), and APIs.

At operation 304, a processor identifies model specifications based on the received model inference simulation requests. A model specification can be determined based on a model identifier included in a model inference simulation request. A model specification can be in JSON format, including metadata associated with the model, such as model object metadata defining model characteristics, feature metadata specifying data transformations, runtime metadata indicating environment requirements, processing codes and configurations, and model file references. Utilizing model specifications in JSON format provides several technical advantages, including allowing a consistent portrayal of model characteristics, preprocessing configurations, and runtime requirements, supporting comprehensive metadata management by capturing complete model metadata, and facilitating runtime consistency by maintaining consistent execution across training, simulation, and production environments. This approach promotes efficient processing by allowing automated parsing and validation of model specifications, as well as facilitating rapid initialization of simulation sessions and automated configuration of runtime environments.

At operation 306, a processor generates job workflows based on the model specifications and/or the model inference simulation requests. A job workflow includes a plurality of jobs, including, without limitation, workflow template selection, workflow initialization, feature processing, model inferencing, and model output processing.

At operation 308, a processor uses machine learning models to generate model inference simulation results based on the corresponding model specifications. The generation of the model inference simulation result can be a multi-step process that includes executing a plurality of jobs based on the job workflow described herein. Specifically, model inference simulation results can be generated through a multi-stage execution process. The process starts by initiating model simulation sessions based on model specifications and files to execute a sequence of jobs. The first stage is feature preprocessing, where the data management system processes input data according to specification rules, handles missing value treatments, applies feature transformations, and validates feature consistency. Next, the model inference stage executes the inference using containerized environments, processing data through selected platforms. In the final stage, result postprocessing merges results from parallel jobs, stores the final output in parquet file format, creates table representations (e.g., Hive), and validates output consistency. In particular, the system can store simulation results as both parquet files and Hive tables, where the Hive table provides a quarriable database-like structure for accessing and analyzing the simulation output data.

At operation 310, a processor causes the display of the model inference simulation result on a user interface.

Though not illustrated, method 300 can include an operation where a graphical user interface is displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 310 or, alternatively, form part of one or more of operations 302 through 310.

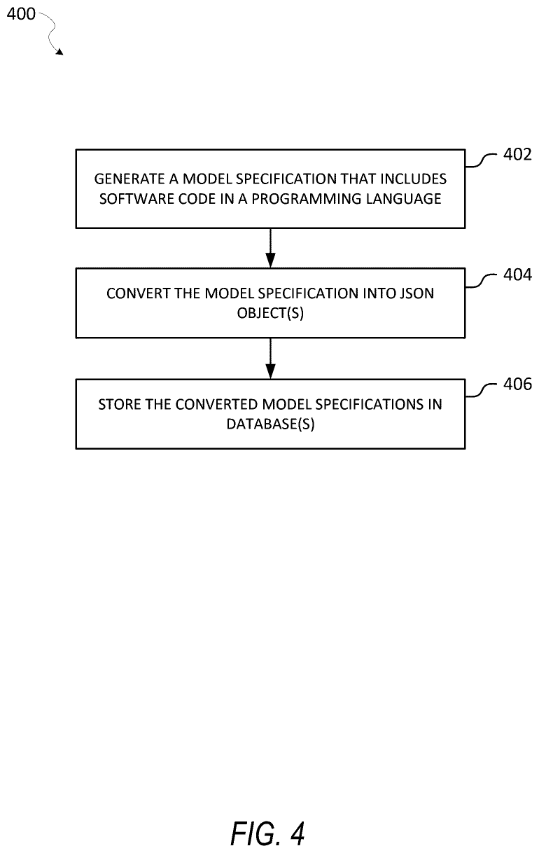

FIG. 4 is a flowchart illustrating an example method 400 for facilitating machine learning model inference simulation for runtime consistency and performance optimization across distributed computing environments, according to various examples of the present disclosure. It will be understood that example methods described herein may be performed by a machine in accordance with some examples. For example, method 400 can be performed by the data management system 122 described with respect to FIG. 1, the data management system 212 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among examples, including performing certain operations in parallel. Operations in method 400 can be performed dependently or independently from operations in method 300.

At operation 402, a processor generates the model specification that includes software code in a programming language. In particular, the model specifications can be generated based on the types and versions of the machine learning models.

At operation 404, a processor converts the model specification into a plurality of JSON objects. A model specification includes software code converted into JSON objects. Keeping model specifications as JSON objects serves to structure the model's data in a standardized, lightweight, and easily readable format, allowing for efficient data exchange and processing. Each JSON object can represent a part of the model specification, such as configuration parameters, function definitions, and metadata associated with the model components.

At operation 406, a processor stores the converted model specification in a database, allowing the models to be securely saved and easily accessible for future reference or updates.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 406 or, alternatively, form part of one or more of operations 402 through 406.

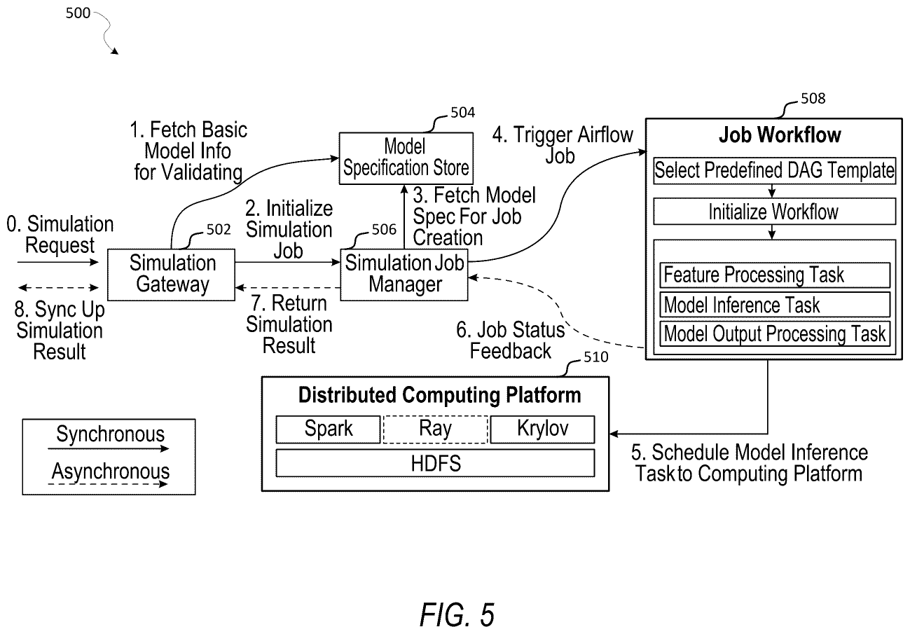

FIG. 5 is a block diagram 500 illustrating an example data flow that facilitates machine learning model inference simulation for runtime consistency and performance optimization across distributed computing environments, according to various examples of the present disclosure. As shown, the data flow includes several key components and processes. The flow begins with a simulation request (step 0) sent to the simulation gateway 502, followed by fetching basic model information from model specification store 504 for validation (step 1), and the initialization of the simulation job by the simulation job manager 506 (step 2).

Subsequently, the model specification is fetched from model specification store 504 for job creation (step 3), triggering a job workflow 508 (step 4). The data management system (e.g., system 122, 212) integrates with multiple distributed computing platforms 510, scheduling the model inference task to these platforms (step 5).

The job workflow 508 proceeds with sequential tasks including selecting a predefined DAG template, initializing the workflow, performing feature processing, model inference, and model output processing tasks.

Job status feedback is provided (step 6) to the simulation job manager 506, followed by returning the simulation result (step 7) to the simulation gateway 502 and syncing the simulation result (step 8). The data flow indicates both synchronous and asynchronous operations, demonstrating the complex interaction between different components of the system.

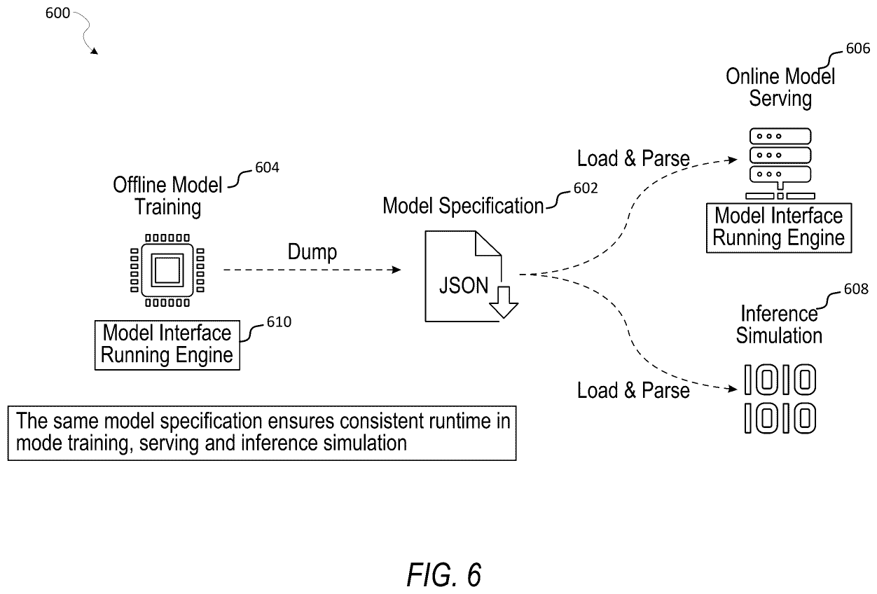

FIG. 6 is a block diagram 600 illustrating an example data flow that facilitates machine learning model inference simulation for runtime consistency and performance optimization across distributed computing environments, according to various examples of the present disclosure. As shown, model specification component 602 stores model specifications in JSON format, serving as a central component that connects offline model training component 604, online model serving component 606, and inference simulation component 608.

The data management system (e.g., system 122, 212) supports bidirectional data flow, with offline model training component 604 dumping data to the model specification component 602. Both online model serving component 606 and inference simulation component 608 load and parse data from the model specification component 602.

The data flow highlights that the same model specification ensures consistent runtime across three key areas: model training, model serving, and inference simulation. It demonstrates how the model inference runtime engine 610 is consistently applied across all three components, ensuring that the runtime environment remains uniform throughout the model's lifecycle.

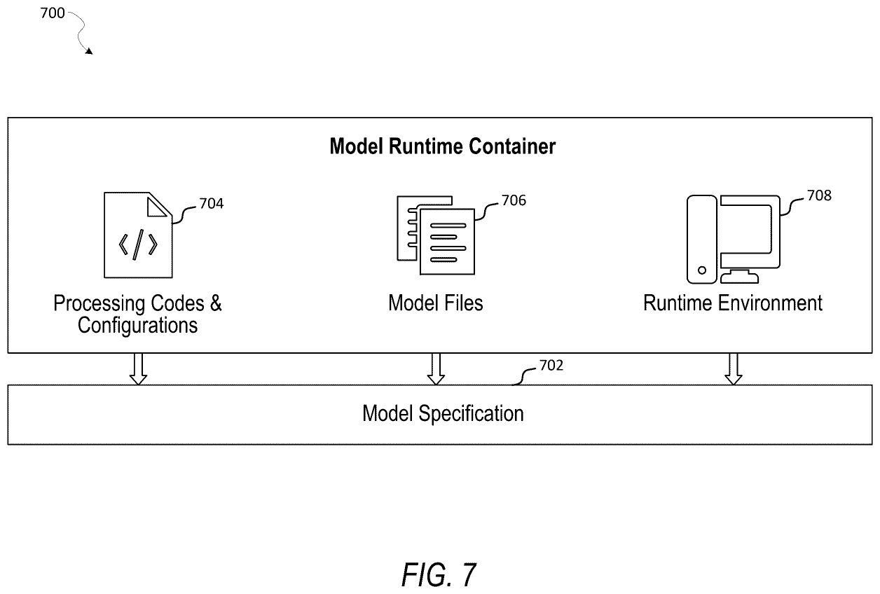

FIG. 7 is a block diagram 700 illustrating an example model specification that facilitates machine learning model inference simulation for runtime consistency and performance optimization across distributed computing environments, according to various examples of the present disclosure. As shown, a model specification 702 can include processing codes and configurations 704, model files 706, and runtime environment 708. These three elements are unified through model specification 702, which serves as a comprehensive metadata repository that describes the entire process and ensures runtime consistency across different environments. The Model Specification acts as the foundation that ties these components together, allowing for consistent model execution whether in training, serving, or simulation environments.

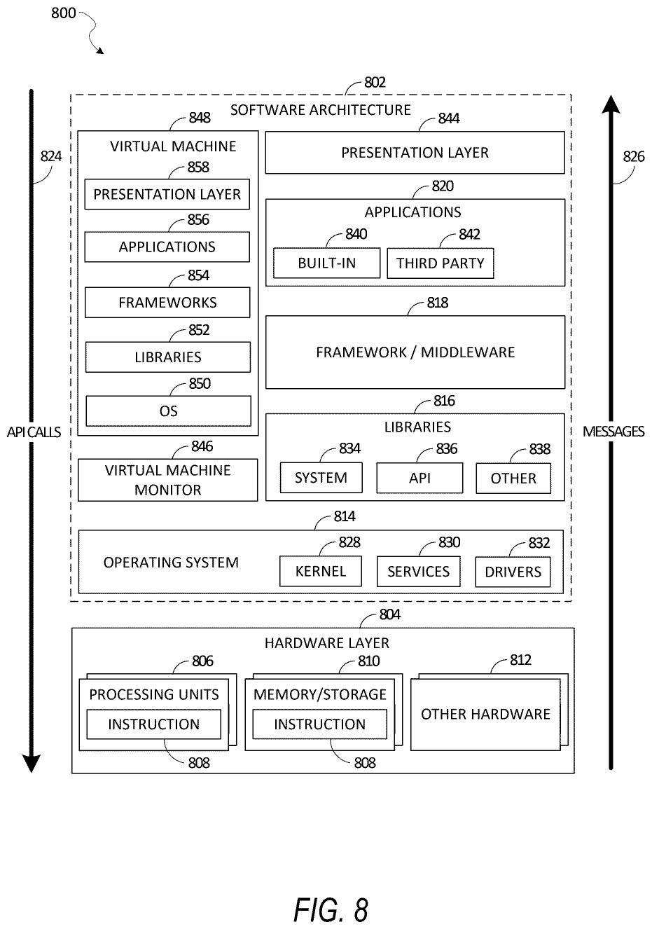

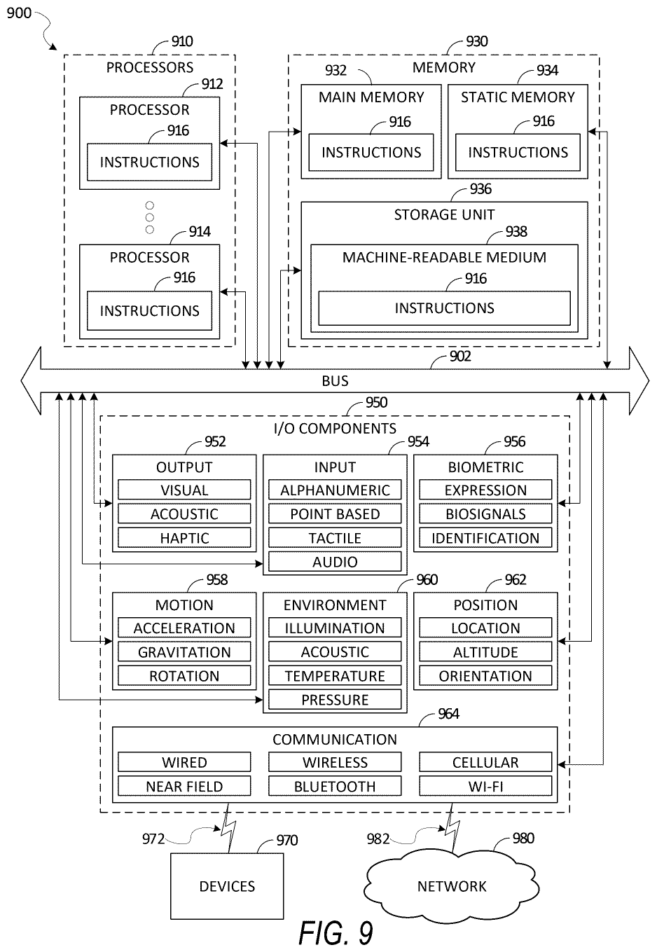

FIG. 8 is a block diagram illustrating an example of a software architecture 802 that may be installed on a machine, according to some examples. FIG. 8 is merely a non-limiting example of software architecture, and it will be appreciated that many other architectures may be implemented to facilitate the functionality described herein. The software architecture 802 may be executing on hardware such as a machine 900 of FIG. 9 that includes, among other things, processors 910, memory 930, and input/output (I/O) components 950. A representative hardware layer 804 is illustrated and can represent, for example, the machine 900 of FIG. 9. The representative hardware layer 804 comprises one or more processing units 806 having associated executable instructions 808. The executable instructions 808 represent the executable instructions of the software architecture 802. The hardware layer 804 also includes memory or storage modules 810, which also have the executable instructions 808. The hardware layer 804 may also comprise other hardware 812, which represents any other hardware of the hardware layer 804, such as the other hardware illustrated as part of the machine 900.

In the example architecture of FIG. 8, the software architecture 802 may be conceptualized as a stack of layers, where each layer provides particular functionality. For example, the software architecture 802 may include layers such as an operating system 814, libraries 816, frameworks/middleware 818, applications 820, and a presentation layer 844. Operationally, the applications 820 or other components within the layers may invoke API calls 824 through the software stack and receive a response, returned values, and so forth (illustrated as messages 826) in response to the API calls 824. The layers illustrated are representative in nature, and not all software architectures have all layers. For example, some mobile or special-purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than by interfacing directly with the underlying operating system 814 functionality (e.g., kernel 828, services 830, or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 or other software components/modules. For example, the frameworks 818 may provide various graphical user interface functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a home application, a contacts application, a browser application, a book reader application, a location application, a media application, a messaging application, or a game application.

The third-party applications 842 may include any of the built-in applications 840, as well as a broad assortment of other applications. In a specific example, the third-party applications 842 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 842 may invoke the API calls 824 provided by the mobile operating system such as the operating system 814 to facilitate functionality described herein.

The applications 820 may utilize built-in operating system functions (e.g., kernel 828, services 830, or drivers 832), libraries (e.g., system libraries 834, API libraries 836, and other libraries 838), or frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with the user.

Some software architectures utilize virtual machines. In the example of FIG. 8, this is illustrated by a virtual machine 848. The virtual machine 848 creates a software environment where applications/modules can execute as if they were executing on a hardware machine (e.g., the machine 900 of FIG. 9). The virtual machine 848 is hosted by a host operating system (e.g., the operating system 814) and typically, although not always, has a virtual machine monitor 846, which manages the operation of the virtual machine 848 as well as the interface with the host operating system (e.g., the operating system 814). A software architecture executes within the virtual machine 848, such as an operating system 850, libraries 852, frameworks 854, applications 856, or a presentation layer 858. These layers of software architecture executing within the virtual machine 848 can be the same as corresponding layers previously described or may be different.

FIG. 9 illustrates a diagrammatic representation of a machine 900 in the form of a computer system within which a set of instructions may be executed for causing the machine 900 to perform any one or more of the methodologies discussed herein, according to some examples. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute method 300 described above with respect to FIG. 3, and method 400 described above with respect to FIG. 4. Instructions 916 transform the general, non-programmed machine 900 into a particular machine 900 programmed to carry out the described and illustrated functions in the manner described. In alternative examples, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example, the processors 910 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936 including machine-readable medium 938, each accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In some examples, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 950 may include biometric components 956, motion components 958, environmental components 960, or position components 962, among a wide array of other components. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

Certain examples are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In examples in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 900 including processors 910), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 900, but deployed across a number of machines 900. In some examples, the processors 910 or processor-implemented modules are located in a single geographic location (e.g., within a home environment, an office environment, or a server farm). In other example embodiments, the processors or processor-implemented modules are distributed across a number of geographic locations.

The various memories (i.e., 930, 932, 934, and/or the memory of the processor(s) 910) and/or the storage unit 936 may store one or more sets of instructions 916 and data structures (e.g., software) embodying or utilized by any one or more of the methodologies or functions described herein. These instructions (e.g., the instructions 916), when executed by the processor(s) 910, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 916 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below. In this context, the machine-storage medium is non-transitory.

In some examples, one or more portions of the network 980 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
a memory storing instructions; and
one or more hardware processors communicatively coupled to the memory and configured by the instructions to perform operations comprising:
receiving a model inference simulation request;
identifying a model specification based on the model inference simulation request;
generating a job workflow based on the model specification and the model inference simulation request;
generating, using a machine learning model associated with the model specification, a model inference simulation result, the generating of the model inference simulation result comprising executing a plurality of jobs based on the job workflow; and
causing display of the model inference simulation result on a user interface.

2. The system of claim 1, wherein the model specification comprises preprocessing code, a plurality of preprocessing configurations, a plurality of model files, and runtime metadata, the runtime metadata indicating a runtime environment in which the machine learning model operates.

3. The system of claim 2, wherein the runtime metadata comprises a plurality of predetermined versions of libraries associated with the machine learning model.

4. The system of claim 1, wherein the machine learning model associated with the model specification comprises one of a distributed gradient-boosting machine learning framework, a deep neural network, or a customized machine learning model that supports specified data formats.

5. The system of claim 1, wherein:
the plurality of jobs in the job workflow is arranged in a logical sequence, and
the plurality of jobs comprises a workflow template selection job, a workflow initialization job, a feature processing job, a model inferencing job, and a model output processing job.

6. The system of claim 1, comprising:
generating the model specification that comprises software code in a programming language;
converting the model specification into a plurality of JSON objects; and
storing the converted model specification in a database.

7. The system of claim 1, comprising:
tuning the machine learning model based on the model inference simulation result.

8. The system of claim 1, wherein the model inference simulation request is received via a user interface, a software library, or an Application Programming Interface (API) call.

9. The system of claim 1, wherein the machine learning model operates on a distributed computing platform that comprises one or more of a distributed computing framework, a software library, and a distributed file system.

10. The system of claim 1, wherein the model specification configured for the machine learning model for model inference simulation is used for offline training of the machine learning model.

11. A method comprising:
receiving a model inference simulation request;
identifying a model specification based on the model inference simulation request;
generating a job workflow based on the model specification and the model inference simulation request;
generating, using a machine learning model associated with the model specification, a model inference simulation result, the generating of the model inference simulation result comprising executing a plurality of jobs based on the job workflow; and
causing display of the model inference simulation result on a user interface.

12. The method of claim 11, wherein the model specification comprises preprocessing code, a plurality of preprocessing configurations, a plurality of model files, and runtime metadata, the runtime metadata indicating a runtime environment in which the machine learning model operates.

13. The method of claim 12, wherein the runtime metadata comprises a plurality of predetermined versions of libraries associated with the machine learning model.

14. The method of claim 11, wherein the machine learning model associated with the model specification comprises one of a distributed gradient-boosting machine learning framework, a deep neural network, or a customized machine learning model that supports specified data formats.

15. The method of claim 11, wherein:
the plurality of jobs in the job workflow is arranged in a logical sequence, and
the plurality of jobs comprises a workflow template selection job, a workflow initialization job, a feature processing job, a model inferencing job, and a model output processing job.

16. The method of claim 11, comprising:
generating the model specification that comprises software code in a programming language;
converting the model specification into a plurality of JSON objects; and
storing the converted model specification in a database.

17. The method of claim 11, comprising:
tuning the machine learning model based on the model inference simulation result.

18. The method of claim 11, wherein the model inference simulation request is received via a user interface, a software library, or an Application Programming Interface (API) call.

19. The method of claim 11, wherein the machine learning model operates on a distributed computing platform that comprises one or more of a distributed computing framework, a software library, and a distributed file system.

20. A computer-storage medium comprising instructions that, when executed by a processing device, cause the processing device to perform operations comprising:
receiving a model inference simulation request;
identifying a model specification based on the model inference simulation request;
generating a job workflow based on the model specification and the model inference simulation request;
generating, using a machine learning model associated with the model specification, a model inference simulation result, the generating of the model inference simulation result comprising executing a plurality of jobs based on the job workflow; and
causing display of the model inference simulation result on a user interface.
